(19) United States
(12) Patent Application Publication
(10) Pub. No.: US 2002/0056751 A1
(43) Pub. Date: May 16, 2002

(54) Food conveyor system with time controls

(76) Inventor: Dong Soo Lee, Addison, IL (US)

Correspondence Address: Alan B. Samlan, Knetchel, Demeur & Samlan, Suite 1410, 222 South Riverside Plaza, Chicago, IL, 60606, US

(21) Appl. No.: 09/990,630

(22) Filed: Nov. 13, 2001

Related U.S. Application Data
(60) Provisional application No. 60/248,413, filed on Nov. 14, 2000.
(60) Provisional application No. 60/248,416, filed on Nov. 14, 2000.
(60) Provisional application No. 60/248,406, filed on Nov. 14, 2000.

(51) Int. Cl. G06K 7/10

(52) U.S. Cl. 235/462.01

(57) ABSTRACT

A method and apparatus for monitoring the length of time that a food product is displayed for sale before it is to be removed. A first group of plates having the food items thereon has character identifying indicia on the top or edge of the plate. The indicia represent a time frame during which the plate was placed on the conveyor system. A second group of plates having other food items thereon has a second character identifying indicia on the top or edge of the plate. This second indicia represents a second time frame during which the plate was placed on the conveyor system. After a predetermined time frame, plates remaining on the conveyor system are removed depending on when they were placed on the conveyor. The character indicia, which can be color-coding or bar codes can identify the plates. Additional groups of plates having their own character indicia can be added to increase the time frames monitored.

### CROSS-REFERENCE TO RELATED APPLICATIONS

This application is based on and claims priority of provisional patent application No. 60/248,413 filed Nov. 14, 2000, provisional patent application No. 60/248,416 filed Nov. 14, 2000 and provisional patent application No. 60/248,406 filed Nov. 14, 2000.

### BACKGROUND AND SUMMARY OF INVENTION

This invention relates to a method and apparatus for monitoring the length of time that a food product is displayed for sale before it is to be removed. This invention is particularly well designed for removing food such as sushi from a conveyor system before it reaches a condition in which it is not fit for human consumption.

Some food restaurants have adopted conveyor belts that distribute food to their patrons. This is especially true for sushi restaurants that are adopting “sushi conveyor belts.” These are very popular in Japan because of its unique operating system. Customers are seated in front of a table, which resembles an airport baggage claim area. On the conveyor belt is a variety of ready-made sushi passing around on the belt in front of the customer. The customer picks the plates containing the desired sushi for his or her consumption. When the customer is ready to leave, a wait staff counts the number of plates that the customer has selected and multiplies the number of plates by the price of each plate. The customer pays the total price calculated in this manner.

Some restaurants in the United States have tried adopting this system by installing the conveyor belt. However, the local health or sanitation departments have not readily accepted it. It is common knowledge, and enforced by code or regulation, that most food should not be left at temperatures between 41° F. and 140° F. for more than four hours. This temperature/time criterion is commonly known as the temperature danger zone. Most sushi is made from raw fish. Thus the four-hour window must be strictly enforced. Frequently the local health department requires less time than the four hours to minimize the possibility of spoiled food being served to patrons. For example, when serving raw fish, the health department may require that the food not remain available on display at the temperature danger zone for more than two hours.

The local health department's main concern is how the restaurants can effectively control the time and temperature that the food remains available for selection by the patron so that the food is absolutely safe to be consumed. The longer the food remains on the conveyor belt, and the higher the temperature, the more likely that harmful bacteria can grow on the food rendering it unsuitable for consumption. In the actual restaurant environment, it becomes extremely difficult to control every single plate on a conveyor belt system when customers are constantly removing plates and sushi chefs are continually refilling the conveyor system with fresh sushi. In this scenario it is possible for any particular plate to be left on the conveyor belt for more than four hours unless a control system is implemented.

The problem arises in that some plates are on the conveyor belt for several hours, and others are just being placed on the conveyor belt. There is not an identification process to identify the plates so that they correspond to a time when they are placed on the conveyor belt. The system must be flexible so that the plates can be identified with a specific time period when they are place on the conveyor belt. The system must also allow for variations in the length of time that the sushi is left on the conveyor belt before it is removed.

Another problem is that the restaurant owner does not want to waste food by throwing out perfectly good sushi merely because he cannot identify when the sushi was placed on the conveyor belt. Applicant's invention provides a method and apparatus for effectively controlling the time sushi is left on the conveyor belt so that only the sushi that is on the belt the prescribed length of time is discarded.

Applicant has solved the problem of identifying when a plate is placed on the food conveyor system. Applicant provides a bar code system that identifies when a plate is placed on the conveyor belt. In a first embodiment, a simple single bar on the plates can designate plates placed on the conveyor belt between 1:00 p.m. and 2:00 p.m. Two bars can be place on plates placed on the conveyor belt between 2:00 p.m. and 3:00 p.m. In this example, if the food is not to be left on the conveyor belt for more than two hours, any plates having one bar thereon, must be removed when it is 3:00 p.m. This guarantees that no plate with one bar on it has remained on the conveyor belt for more than two hours.

In another embodiment, color-coded plates can be used to achieve the same results. The system can also be modified to provide more precise control and provide less loss, by using shorter time frames. For instance, one bar on a plate can be used for 1:00 p.m. to 1:30 p.m. Two bars can be used for 1:31 p.m. to 2:00 p.m. Three bars can be used for 2:01 p.m. to 2:30 p.m. and so forth. After a couple of hours, the cycle can repeat itself. In this manner, there will be less food thrown out due to it being on the conveyor belt for over the prescribed time.

### OBJECTS AND ADVANTAGES

Thus it is an object of the invention to supply a system that provides information about the time that a plate is placed on a conveyor system for determining the overall time that the plate remains on the conveyor system. A related object is to place indicia on the plates such as a bar code system that corresponds to various times when the plate is place on the conveyor system. Yet another object is to color-code the plates so that each color corresponds to a specific time or time frame when the plate is placed on the conveyor system.

Another object is to provide a method of identifying individual plates on a sushi conveyor system and providing means to identify the time when the plate was placed on the conveyor system so that the time when the plate must be removed can be readily determined. A related object is providing a system for removing plates from a sushi conveyor system after the plate has been on the conveyor system a predetermined length of time.

These and other objects and advantages will be apparent upon reading the description of the drawings and detailed description of the preferred embodiment.

### DESCRIPTION OF THE DRAWINGS

FIG. 1 is a top plan view of a sushi conveyor system illustrating the seating of patrons around the conveyor belt and the path of the belt through the eating area and the kitchen area.

FIG. 2 is an enlarged view with portions removed of the belt with plates of food placed thereon.

FIG. 3 is a top plan view of four plates each having a different bar code placed on the border of the plate.

FIG. 4 is a top plan view of an alternative design of thee plates each having a different color placed in the border of the plate.

FIG. 5 is a top plan view of an alternative plate design in which a scannable bar code is placed in the border area of the plate.

FIG. 6 is an end view of an alternative plate design in which the scannable bar code is located on the edge of the plate.

FIG. 7 is a side elevation view with portions removed of the conveyor belt with a scanner placed above the conveyor belt to read the bar code on the plate.

FIG. 8 is a top plan vies of the conveyor belt of FIG. 7 with portion removed.

### DESCRIPTION OF THE PREFERRED EMBODIMENT

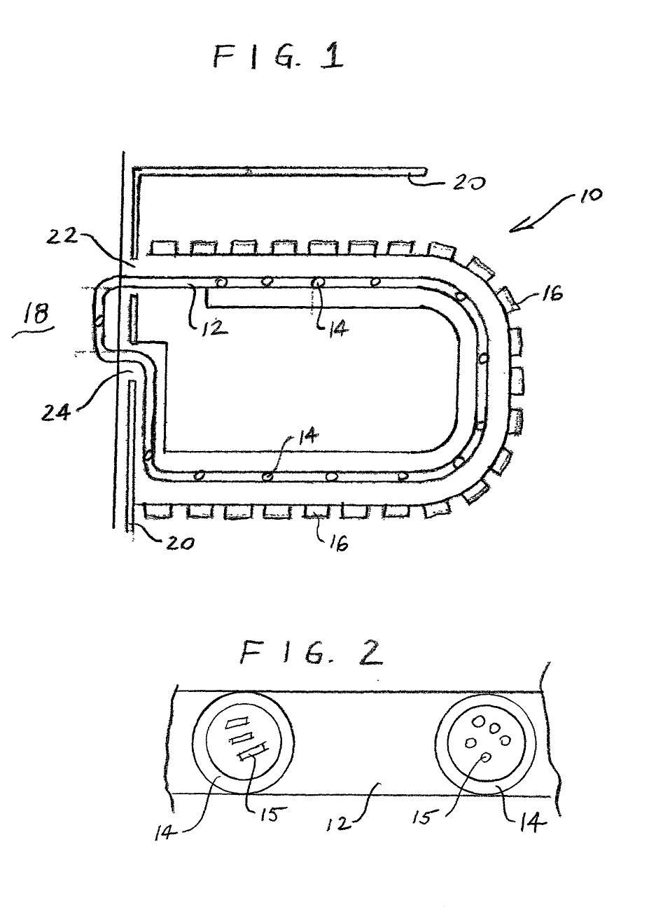

Turning first to FIG. 1 there is illustrated a top plan view of a food conveyor system 10 which has a conveyor belt 12 that travels around a predetermined path. In the preferred embodiment the particular application is a sushi conveyor system in which individual plates 14 with sushi 15 thereon are placed on the conveyor belt 12 (See FIG. 2). Placed around the conveyor belt 12 is a plurality of seats 16 on which restaurant patrons are seated. As the plates pass in front of the restaurant patrons, they remove the desired plate having the selected sushi thereon. The patron pays at the end of the meal based upon the plates that the patron removed from the conveyor belt.

The eating area is separated from a kitchen area 18 by means of wall 20. Two openings 22 and 24 in the wall 20 provide an entrance and exit for the conveyor belt 12 to and from the kitchen area 18. The chef and kitchen staff are located in the kitchen area 18 where the food is prepared and placed upon the conveyor belt 12.

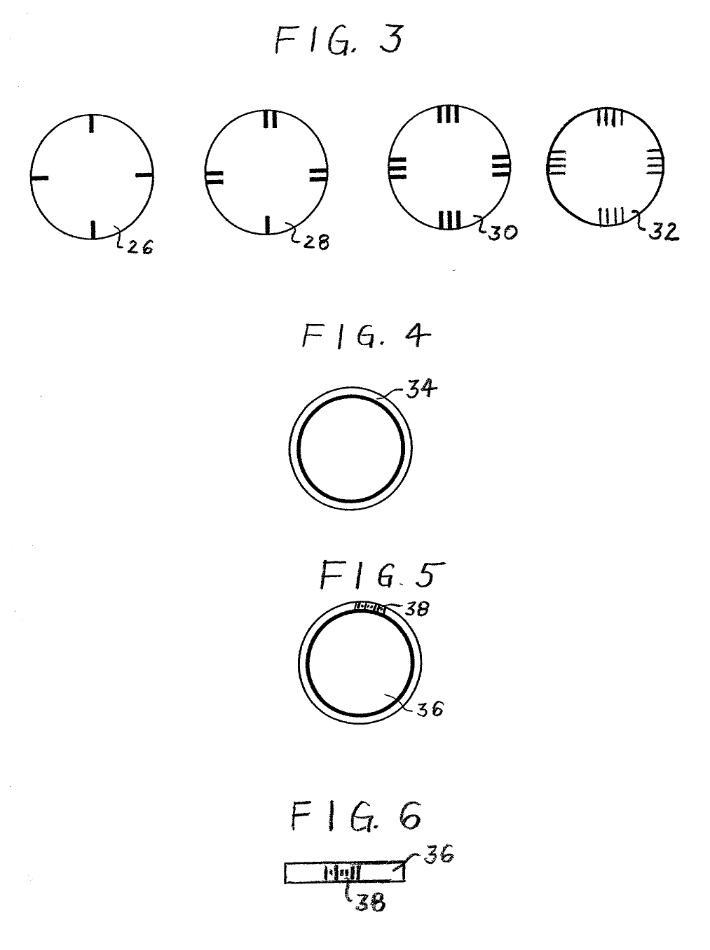

It is important that the food not be left out for more than the allowed time before it is consumed in order to minimize the likelihood of the restaurant patrons getting sick from bacteria that grows on the food. Generally the health departments will not allow the food to remain out on the conveyor belt for more than two hours before it must be thrown away. Other health departments may require impose shorter or longer time periods. For illustrative purposes we will assume that a two-hour time period is allowed by the health codes. Applicant provides a series of plates 26, 28, 30, and 32 as illustrated in FIG. 3. Plate 26 has one bar placed in each quadrant of the top surface of the plate. Plate 28 has two bars in each quadrant. Plate 30 has three bars and plate 32 has four bars in each quadrant. The bars are visible when the plate is on the conveyor belt 12.

If the restaurant opens at 1:00 p.m., the sushi chef prepares the sushi in the kitchen area 18 and places it on the plates 26 having one bar. These are placed on the conveyor belt 12 and circulated around the entire conveyor system 10. The plates 26 having one bar are used until 1:59 p.m. At 2:00 p.m. the sushi chef uses the plates 28 having two bars. These are used from 2:00 p.m. until 2:59 p.m. At 3:00 p.m. the sushi chef uses the plates 30 having three bars. At the same time, any plates 26 having one bar are removed from the conveyor belt 12 when the plates 26 enter the kitchen area 18 through the opening 22. In this manner no plate 26 remains on the conveyor belt 12 for more than two hours. At 4:00 p.m. the sushi chef uses the plates 32 having four bars. The plates having two bars are removed from the conveyor belt 12 in the kitchen area 18. Thus the plates 28 do not remain on the conveyor belt 12 for more than two hours. At 5:00 p.m. the plates 26 having one bar on them are again used and the plates with three bars are removed. The process keeps repeating while the restaurant is open.

In the above example the time frame chosen was one-hour increments for changing plates. This may result in some of the plates being on the conveyor belt 12 for as much as two hours if placed on the belt at 1:00 p.m. and not removed until 3:00 p.m. or as little as one-hour if the plate is placed on the belt at 1:59 p.m. and removed at 3:00 p.m. If a time increment of one-half hour is selected, plates 26 with one bar are placed on the belt at 1:00 p.m. At 1:30 p.m. plates 28 with two bars are used and at 2:00 p.m. plates 30 with three bars are used. At 2:30 plates 32 with four bars are used and at 3:00 p.m. plates with five bars are used and the plates 26 with one bar are removed. At 3:30 p.m. the plates with two bars are removed and so forth. The advantage of using a shorter time increment is that the longest time that plates can remain on the conveyor belt is still two hours, but the shortest time has been increased to one and one-half hours from one hour in the previous example. This results in less likelihood of throwing away food that is still suitable for consumption by the restaurant patron.

As seen in FIG. 4 there is another embodiment of the plates. There is a border area 34 around the outer circumference of the plates. The color area is provided with a color so that there are a series of plates, each with a different color. This is the equivalent of using different bar codes. The sequence of placing the plates on the conveyor belt is established so that for example yellow may represent 1:00 p.m., green 1:30 p.m., blue 2:00 p.m. etc. The removal of the plates after the predetermined time period remains the same as in the above examples.

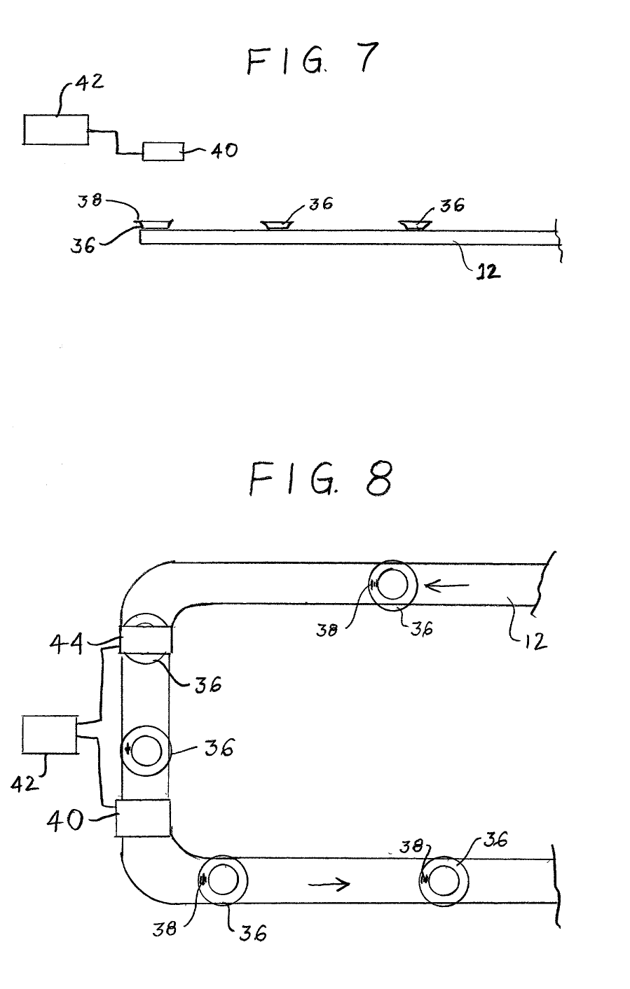

In another embodiment as illustrated in FIG. 5, a plate 36 is supplied with a unique scannable bar code 38. Each plate 36 has a different unique bar code. The bar code 38 can be place at the top or side edge of the plate 38 such as seen in FIG. 6. As seen in FIG. 7, a scanner mounted above the conveyor belt 12. The scanner is located at a position just after the sushi chef places the plate 36 on the conveyor belt 12. The scanner and sushi chef are preferably in the kitchen area 18. The scanner 40 is connected to a general purpose computer 42. The scanner 40 reads the bar code 38 and stores the information unique to that plate in a memory in the computer 42. At the same time the computer enters the time that the plate 36 was placed on the conveyor belt 12. Thus each plate 36 has a time associated with it when it is placed on the conveyor belt 12.

A second scanner 44 is located above the conveyor belt 12 so that it also can read the bar code 38. The location of the scanners 40 and 42 and the bar code 38 on the plates are only dependent on the ability of the scanners 40 and 42 to be able to see and read the bar code 38.

The scanner 44 is also connected to the computer 42. The scanner 44 sends a signal to the computer 42 corresponding to the bar code 38 and the computer calculates the time that the plate 36 is on the conveyor belt 12. If the time exceeds the permissible time, a signal is generated advising the sushi chef, or other person, to remove the plate. An automatic system can also be used in which a mechanical arm can push the plate off of the conveyor belt in response to receiving the signal from the computer 42 that the plate has been on the conveyor belt for the allowed time. In this manner very tight time controls can be maintained over each individual plate so that the plates are not removed too early before their allowed time is reached.

Thus there has been provided a food conveyor system that fully satisfies the objects set forth above. While the invention has been described in conjunction with a specific embodiment, it is evident that many alternatives, modifications and variations will be apparent to those skilled in the art in light of the foregoing description. Accordingly, it is intended to embrace all such alternatives, modifications and variations as fall within the spirit and scope of the appended claims.

What is claimed is:

1. A food conveyor system comprising:
conveyor means for transporting a plurality of plates having a food product thereon around a predetermined conveyor path, the plates being adapted for individual removal by persons desiring to consume the food product;
a first plurality of serving plates having a first color indicating means thereon comprising a first group of plates placed on the conveyor means, the first color indicating means identifying the plate as one plate among the first group of plates;
a second plurality of serving plates having a second color indicating means thereon comprising a second group of plates on the conveyor means, the second color indicating means identifying the plate as one plate among the second group of plates;
the first group of plates placed on the conveyor means during a first prescribed time frame and the first color indicating means identifying the first group of plates being placed on the conveyor means during the first prescribed time frame;
the second group of plates placed on the conveyor means during a second prescribed time frame and the second color indicating means identifying the second group of plates placed on the conveyor means during the second prescribed time frame;
means to remove an individual plate from the first group of plates from the conveyor means after the individual plate among the first group of plates has been on the conveyor means a predetermined length of time without being removed by the person desiring to consume the food product; and
means to remove an individual plate from the second group of plates from the conveyor means after the individual plate among the second group of plates has been on the conveyor means a predetermined length of time without being removed by the person desiring to consume the food product.

2. The food conveyor system of claim 1 and further comprising:
a third plurality of serving plates having a third color indicating means thereon comprising a third group of plates placed on the conveyor means, the third color indicating means identifying the plate as one plate among the third group of plates, the third color indicating means being distinct from the first and second color indicating means;
the third group of plates placed on the conveyor means during a third prescribed time frame and the third color indicating means identifying the third group of plates placed on the conveyor means during the third prescribed time frame;
and means to remove an individual plate from the third group of plates from the conveyor means after the individual plate among the third group of plates has been on the conveyor means a predetermined length of time without being removed by the person desiring to consume the food product on the plate.

3. The food conveyor system of claim 2 and further comprising:
a fourth plurality of serving plates having a fourth color indicating means thereon comprising a fourth group of plates placed on the conveyor means, the fourth color indicating means identifying the plate as one plate among the fourth group of plates, the fourth color indicating means being distinct from the first, second and third color indicating means;
the fourth group of plates placed on the conveyor means during a fourth prescribed time frame and the fourth color indicating means identifying the fourth group of plates placed on the conveyor means during the fourth prescribed time frame;
and means to remove an individual plate from the fourth group of plates from the conveyor means after the individual plate among the fourth group of plates has been on the conveyor means a predetermined length of time without being removed by the person desiring to consume the food product on the plate.

4. The conveyor system of claim 1 and further comprising a conveyor belt separating the conveyor system into two distinct areas, a first area in which the food product is placed on the conveyor system and a second area in which the food product is selected and removed from the conveyor belt for consumption by the person, the first area not readily visible from the second area.

5. A food conveyor system comprising:
conveyor means for receiving and transporting a plurality of plates around a predetermined conveyor path;
a first group of plates, each plate of the first group having a first readable indicia thereon which is the same for each plate in the first group;
a second group of plates, each plate of the second group having a second readable indicia thereon which is the same for each plate in the second group but different than the first readable indicia;
the readable indicia on the first group of plates representing a time frame when the first group of plates is placed on the conveyor means, the second readable indicia on the second group of plates representing a second time frame when the second group of plates is placed on the conveyor means, the first group of plates being identified and removed from the conveyor means after a predetermined time and the second group of plates being identified and removed after a second predetermined time.

6. The food conveyor system of claim 5 and further comprising a third group of plates having a third readable indicia thereon which is the same for each plate in the third group but different than the first and second readable indicia, the third readable indicia on the third group of plates representing a third time frame when the third group of plates is placed on the conveyor means, the third group of plates being identified and removed from the conveyor means after a third predetermined time.

7. The food conveyor system of claim 6 and further comprising a fourth group of plates having a fourth readable indicia thereon which is the same for each plate in the fourth group but different than the first, second and third readable indicia, the fourth readable indicia on the fourth group of plates representing a fourth time frame when the fourth group of plates is placed on the conveyor means, the fourth group of plates being identified and removed from the conveyor means after a fourth predetermined time.

8. The food conveyor system of claim 5 wherein the first readable indicia is a bar code.

9. The food conveyor system of claim 8 wherein the second readable indicia is a bar code.

10. A food conveyor system comprising:
conveyor means for receiving and transporting a plurality of plates around a predetermined conveyor path;
a unique character indicia on each plate;
means for reading the unique character indicia and to transmit a signal representative of the unique character indicia to a central processing means;
means to associate a time with receiving the signal representative of the unique character indicia, the time representing when the plate is placed on the conveyor means;
and means for periodically scanning the conveyor means for detecting whether the plate with the unique character indicia is still present on the conveyor means after a predetermined time period; and
means for removing the plate after the predetermined time period if the plate is still present on the conveyor means.

11. The food conveyor system of claim 10 wherein the means for reading the unique character indicia comprises a scanner.

12. The food conveyor system of claim 11 wherein the unique character indicia comprises a unique bar code applied to each plate.

13. The food conveyor system of claim 10 wherein the means for removing the plate from the conveyor means comprises a mechanical arm that is controlled by the central processing means and is operated responsive to a signal generated by the central processing means in response to detecting that the plate is on the conveyor means after the predetermined time period.

14. A method for controlling the freshness of food on a conveyor system comprising the steps of:
providing a conveyor means for displaying food items to consumers positioned around the conveyor means;
providing a first group of plates with the food items thereon to the conveyor system, each of the first group of plates having identifying indicia thereon, the identifying indicia indicating a time frame when the first group of plates are placed on the conveyor system;
providing a second group of plates with other food items thereon to the conveyor system, each of the second group of plates having identifying indicia thereon, the identifying indicia indicating a second time frame when the second group of plates are placed on the conveyor system;
identifying any plates of the first group remaining on the conveyor system after a first predetermined time;
removing from the conveyor system the identified plates from the first group of plates after the first predetermined time period if the plate is still on the conveyor system; and
removing the second group of plates from the conveyor system after a second predetermined time period if the plate is still on the conveyor system.

15. The method of claim 14 and the further step of:
providing a third group of plates with still other food items thereon to the conveyor system, each of the third group of plates having identifying indicia thereon, the identifying indicia indicating a third time frame when the third group of plates are placed on the conveyor system;
identifying any plates of the third group remaining on the conveyor system after a third predetermined time; and
removing from the conveyor system the identified plates from the third group of plates after the third predetermined time period if the plate is still on the conveyor system.

16. The method of claim 14 and the further step of:
selecting the first and second predetermined time periods so that the first and second group of plates are simultaneously on the conveyor system for at least of portion of the same time period.

17. The method of claim 14 and the further step of providing color-coded plates as the identifying indicia.

18. The method of claim 14 and the further step of providing bar-coded plates as the identifying indicia.

19. The method of claim 14 and the further step of providing an area for removing the identified plates that is physically separated from the consumers positioned around the conveyor system.

20. The method of claim 19 and the further step of visually separating the area for removing the identified plates from the consumers positioned around the conveyor system.
